(19) United States
(12) Patent Application Publication
(10) Pub. No.: US 2009/0232666 A1
(43) Pub. Date: Sep. 17, 2009

(54) Linear Compressor

(75) Inventors: Bong-Jun Choi, Kyungsangnam-Do (KR); Hyun Kim, Kyungsangnam-Do (KR); Jong-Min Shin, Busan (KR); Chang-Yong Jang, Gwangju (KR); Shin-Hyun Park, Busan (KR); Young-Hoan Jeon, Kyungsangnam-Do (KR); Chul-Gi Roh, Kyungsangnam-Do (KR)

Correspondence Address: BIRCH STEWART KOLASCH & BIRCH, PO BOX 747, FALLS CHURCH, VA, 22040-0747, US

(73) Assignee: LG Electronics, Inc., Seoul (KR)

(21) Appl. No.: 11/660,733

(22) PCT Filed: Aug. 30, 2004
(86) PCT No.: PCT/KR2004/002180

§ 371 Date: Oct. 10, 2007

(51) Int. Cl. F04B 49/00; F04B 35/04; H02K 33/02; H02P 31/00

(52) U.S. Cl. 417/212; 417/417; 310/30; 318/127

(57) ABSTRACT

The present invention discloses a linear compressor in which a piston is driven by a linear motor and linearly reciprocated inside a cylinder to suck, compress and discharge refrigerants. Even though load is varied, the linear compressor performs the operation in a resonance state by estimating a natural frequency of the piston and synchronizing an operation frequency of the linear motor with the natural frequency of the piston, and efficiently handles the load by varying a compression capacity by changing a stroke of the piston.

### TECHNICAL FIELD

The present invention relates to a linear compressor which can rapidly overcome load and improve compression efficiency, by synchronizing an operation frequency of a linear motor with a natural frequency of a movable member varied by the load, and varying a stroke of the movable member according to the load.

### BACKGROUND ART

In general, a compressor that is a mechanical apparatus for increasing a pressure, by receiving power from a power unit system such as an electric motor or turbine and compressing air, refrigerants or other various operation gases has been widely used for home appliances such as a refrigerator and an air conditioner or in the whole industrial fields.

The compressors are roughly divided into a reciprocating compressor having a compression space through which operation gases are sucked or discharged between a piston and a cylinder, so that the piston can be linearly reciprocated inside the cylinder to compress refrigerants, a rotary compressor having a compression space through which operation gases are sucked or discharged between an eccentrically-rotated roller and a cylinder, so that the roller can be eccentrically rotated on the inner walls of the cylinder to compress refrigerants, and a scroll compressor having a compression space through which operation gases are sucked or discharged between an orbiting scroll and a fixed scroll, so that the orbiting scroll can be rotated with the fixed scroll to compress refrigerants.

Recently, among the reciprocating compressors, a linear compressor has been mass-produced because it has high compression efficiency and simple structure by removing mechanical loss by motion conversion by directly connecting a piston to a driving motor performing linear reciprocation.

Generally, the linear compressor which sucks, compresses and discharges refrigerants by using a linear driving force of the motor includes a compression unit consisting of a cylinder and a piston for compressing refrigerant gases, and a driving unit consisting of a linear motor for supplying a driving force to the compression unit.

In detail, in the linear compressor, the cylinder is fixedly installed in a closed vessel, and the piston is installed in the cylinder to perform linear reciprocation. When the piston is linearly reciprocated inside the cylinder, refrigerants are sucked into a compression space in the cylinder, compressed and discharged. A suction valve assembly and a discharge valve assembly are installed in the compression space, for controlling suction and discharge of the refrigerants according to the inside pressure of the compression space.

In addition, the linear motor for generating a linear motion force to the piston is installed to be connected to the piston. An inner stator and an outer stator formed by stacking a plurality of laminations at the periphery of the cylinder in the circumferential direction are installed on the linear motor with a predetermined gap. A coil is coiled inside the inner stator or the outer stator, and a permanent magnet is installed at the gap between the inner stator and the outer stator to be connected to the piston.

Here, the permanent magnet is installed to be movable in the motion direction of the piston, and linearly reciprocated in the motion direction of the piston by an electromagnetic force generated when a current flows through the coil. Normally, the linear motor is operated at a constant operation frequency f_{c}, and the piston is linearly reciprocated by a predetermined stroke S.

On the other hand, various springs are installed to elastically support the piston in the motion direction even though the piston is linearly reciprocated by the linear motor. In detail, a coil spring which is a kind of mechanical spring is installed to be elastically supported by the closed vessel and the cylinder in the motion direction of the piston. Also, the refrigerants sucked into the compression space serve as a gas spring.

The coil spring has a constant mechanical spring constant Kₘ, and the gas spring has a gas spring constant K_{g} varied by load. A natural frequency fₙ of the piston (or linear compressor) is calculated in consideration of the mechanical spring constant Kₘ and the gas spring constant K_{g}.

The thusly-calculated natural frequency fₙ of the piston determines the operation frequency f_{c} of the linear motor. The linear motor improves efficiency by equalizing its operation frequency f_{c} to the natural frequency fₙ of the piston, namely, operating in the resonance state.

Accordingly, in the linear compressor, when a current is applied to the linear motor, the current flows through the coil to generate an electromagnetic force by interactions with the outer stator and the inner stator, and the permanent magnet and the piston connected to the permanent magnet are linearly reciprocated by the electromagnetic force.

Here, the linear motor is operated at the constant operation frequency f_{c}. The operation frequency f_{c} of the linear motor is equalized to the natural frequency fₙ of the piston, so that the linear motor can be operated in the resonance state to maximize efficiency.

As described above, when the piston is linearly reciprocated inside the cylinder, the inside pressure of the compression space is changed. The refrigerants are sucked into the compression space, compressed and discharged according to changes of the inside pressure of the compression space.

The linear compressor is formed to be operated at the operation frequency f_{c} identical to the natural frequency fₙ of the piston calculated by the mechanical spring constant Kₘ of the coil spring and the gas spring constant K_{g} of the gas spring under the load considered in the linear motor at the time of design. Therefore, the linear motor is operated in the resonance state merely under the load considered on design, to improve efficiency.

However, since the actual load of the linear compressor is varied, the gas spring constant K_{g} of the gas spring and the natural frequency fₙ of the piston calculated by the gas spring constant K_{g} are changed.

In detail, as illustrated in FIG. 1A, the operation frequency f_{c} of the linear motor is determined to be identical to the natural frequency fₙ of the piston in a middle load area at the time of design. Even if the load is varied, the linear motor is operated at the constant operation frequency f_{c}. But, as the load increases, the natural frequency fₙ of the piston increases.

$${f}_{n} = \frac{1}{2 π} \sqrt{\frac{{K}_{m} + {K}_{g}}{M}} \qquad Formula 1$$

Here, fₙ represents the natural frequency of the piston, Kₘ and K_{g} represent the mechanical spring constant and the gas spring constant, respectively, and M represents a mass of the piston.

Generally, since the gas spring constant K_{g} has a small ratio in the total spring constant Kₜ, the gas spring constant K_{g} is ignored or set to be a constant value. The mass M of the piston and the mechanical spring constant Kₘ are also set to be constant values. Therefore, the natural frequency fₙ of the piston is calculated as a constant value by the above Formula 1.

However, the more the actual load increases, the more the pressure and temperature of the refrigerants in the restricted space increase. Accordingly, an elastic force of the gas spring itself increases, to increase the gas spring constant K_{g}. Also, the natural frequency fₙ of the piston calculated in proportion to the gas spring constant K_{g} increases.

Referring to FIGS. 1A and 1B, the operation frequency f_{c} of the linear motor and the natural frequency fₙ of the piston are identical in the middle load area, so that the piston can be operated to reach a top dead center (TDC), thereby stably performing compression. In addition, the linear motor is operated in the resonance state, to maximize efficiency of the linear compressor.

However, the natural frequency fₙ of the piston gets smaller than the operation frequency f_{c} of the linear motor in a low load area, and thus the piston is transferred over the TDC, to apply an excessive compression force. Moreover, the piston and the cylinder are abraded by friction. Since the linear motor is not operated in the resonance state, efficiency of the linear compressor is reduced.

In addition, the natural frequency fₙ of the piston becomes larger than the operation frequency f_{c} of the linear motor in a high load area, and thus the piston does not reach the TDC, to reduce the compression force. The linear motor is not operated in the resonance state, thereby decreasing efficiency of the linear compressor.

As a result, in the conventional linear compressor, when the load is varied, the natural frequency fₙ of the piston is varied, but the operation frequency f_{c} of the linear motor is constant. Therefore, the linear motor is not operated in the resonance state, which results in low efficiency. Furthermore, the linear compressor cannot actively handle and rapidly overcome the load.

On the other hand, in order to rapidly overcome the load, as shown in FIG. 2, the conventional linear compressor allows the piston 6 to be operated inside the cylinder 4 in a high or low refrigeration mode by adjusting an amount of current applied to the linear motor. The stroke S of the piston 6 is varied according to the operation modes, to change a compression capacity.

The linear compressor is operated in the high refrigeration mode in a state where the load is relatively large. In the high refrigeration mode, the operation frequency f_{c} of the linear motor is equalized to the natural frequency fₙ of the piston 6, so that the piston 6 can be operated to reach the TDC with a predetermined stroke S1.

In addition, the linear compressor is operated in the low refrigeration mode in a state where the load is relatively small. In the low refrigeration mode, the compression capacity can be reduced by lowering the operation frequency f_{c} of the linear motor by decreasing the current applied to the linear motor. However, in a state where the piston 6 is elastically supported in the motion direction by the elastic force of the mechanical spring and the gas spring, a stroke S2 of the piston 6 is reduced. Accordingly, the piston 6 cannot reach the TDC, which results in low efficiency and compression force of the linear compressor.

### DISCLOSURE OF THE INVENTION

The present invention is achieved to solve the above problems. An object of the present invention is to provide a linear compressor which can efficiently vary a compression capacity according to load, by controlling an operation frequency of a linear motor and a stroke of a piston, even if a natural frequency of the piston is varied by the load.

In order to achieve the above-described object of the invention, there is provided a linear compressor, including: a fixed member having a compression space inside; a movable member linearly reciprocated in the fixed member in the axial direction, for compressing refrigerants sucked into the compression space; one or more springs installed to elastically support the movable member in the motion direction of the movable member, spring constants of which being varied by load; and a linear motor installed to be connected to the movable member, for linearly reciprocating the movable member in the axial direction, an operation frequency and a stroke being varied by the load.

Preferably, the linear compressor is installed in a refrigeration/air conditioning cycle, and the load is calculated in proportion to a difference between a pressure of condensing refrigerants (condensing pressure) and a pressure of evaporating refrigerants (evaporating pressure) in the refrigeration/air conditioning cycle. More preferably, the load is additionally calculated in proportion to a pressure that is an average of the condensing pressure and the evaporating pressure (average pressure).

Preferably, the linear motor is operated in a resonance state by synchronizing its operation frequency with a natural frequency of the movable member varied in proportion to the load.

Preferably, even though the stroke is varied by the load, the linear motor maintains efficiency of the linear compressor and a compression force of the refrigerants, by linearly reciprocating the movable member to reach a top dead center.

Preferably, the linear motor includes: an inner stator formed by stacking a plurality of laminations in the circumferential direction to cover the periphery of the fixed member; an outer stator disposed outside the inner stator at a predetermined interval, and formed by stacking a plurality of laminations in the circumferential direction; a coil wound body installed at any one of the inner stator and the outer stator, for generating an electromagnetic force between the inner stator and the outer stator according to current flow; and a permanent magnet positioned at the gap between the inner stator and the outer stator, connected to the movable member, and linearly reciprocated by interactions with the electromagnetic force of the coil wound body.

Here, the coil wound body is divided into two or more coil wound sections in the axial direction, and the linear motor includes a branch means for selecting one or more coil wound sections and applying an input current to the selected coil wound sections, and a control means for controlling the branch means according to the load.

Preferably, the branch means selects two of both end points of the coil wound body and connection points between the coil wound sections, and applies the input current to the selected points. More preferably, the branch means selects the point adjacent to the top dead center between the both end points of the coil wound body.

Accordingly, when the linear motor applies the current to the coil wound body, the electromagnetic force is always generated at the point of the coil wound body adjacent to the top dead center, and the permanent magnet is linearly reciprocated by the interactions with the electromagnetic force of the coil wound body, so that the piston can reach the top dead center to improve efficiency of the linear compressor and the compression force of the refrigerants.

The stroke is controlled in proportion to the axial direction length of the coil wound sections to which the current is applied, and the coil wound sections of the coil wound body have different inductance. In each of the coil wound sections, a coil wound number is different or a different diameter of coils are wound.

For example, the coil wound body is divided into first and second coil wound sections from the top dead center, and the axial direction length of the first coil wound section is preferably 30 to 80% of the axial direction length of the coil wound body in order to achieve optimum efficiency in low load.

### BRIEF DESCRIPTION OF THE DRAWINGS

The present invention will become better understood with reference to the accompanying drawings which are given only by way of illustration and thus are not limitative of the present invention, wherein:

FIG. 1A is a graph showing a stroke by load in a conventional linear compressor;

FIG. 1B is a graph showing efficiency by the load in the conventional linear compressor;

FIG. 2 is a structure view illustrating the stroke in operation mode of the conventional linear compressor;

FIG. 3 is a cross-sectional view illustrating a linear compressor in accordance with the present invention;

FIG. 4A is a graph showing a stroke by load in the linear compressor in accordance with the present invention;

FIG. 4B is a graph showing efficiency by the load in the linear compressor in accordance with the present invention;

FIG. 5 is a graph showing changes of a gas spring constant by the load in the linear compressor in accordance with the present invention;

FIG. 6 is a structure view illustrating a linear motor of FIG. 3;

FIG. 7A is an operational state view illustrating an operation state of the linear compressor in a low refrigeration mode in accordance with the present invention; and

FIG. 7B is an operational state view illustrating an operation state of the linear compressor in a high refrigeration mode in accordance with the present invention.

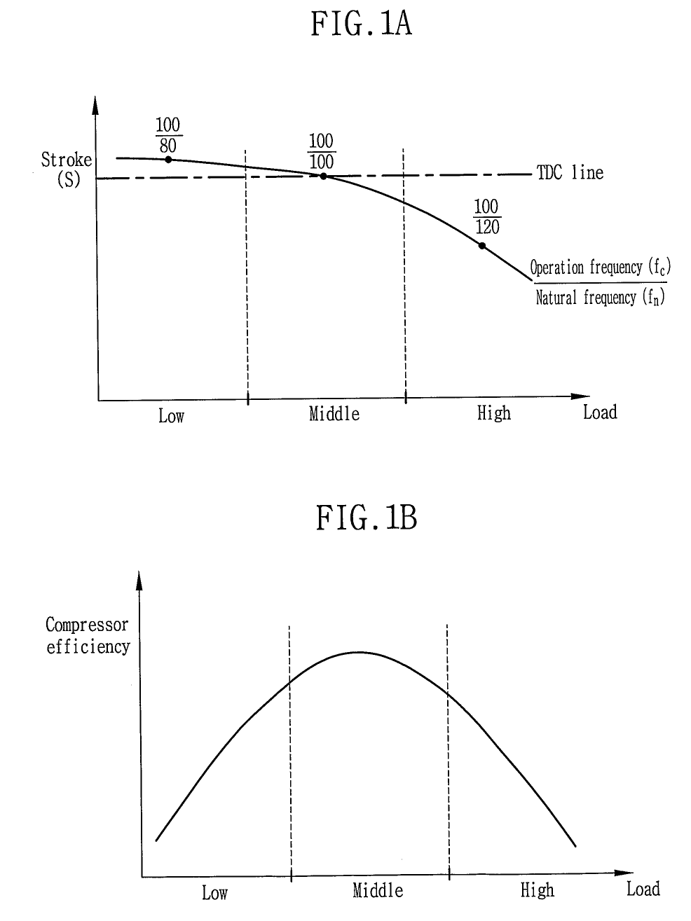

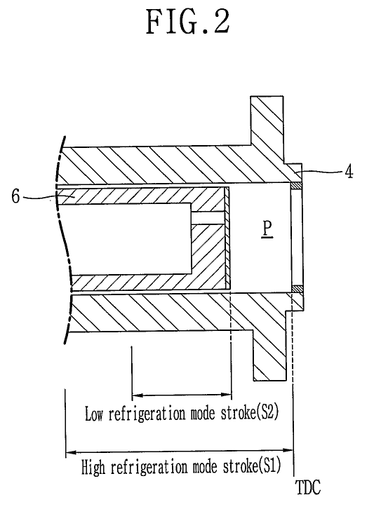

### BEST MODE FOR CARRYING OUT THE INVENTION

A linear compressor in accordance with preferred embodiments of the present invention will now be described in detail with reference to the accompanying drawings.

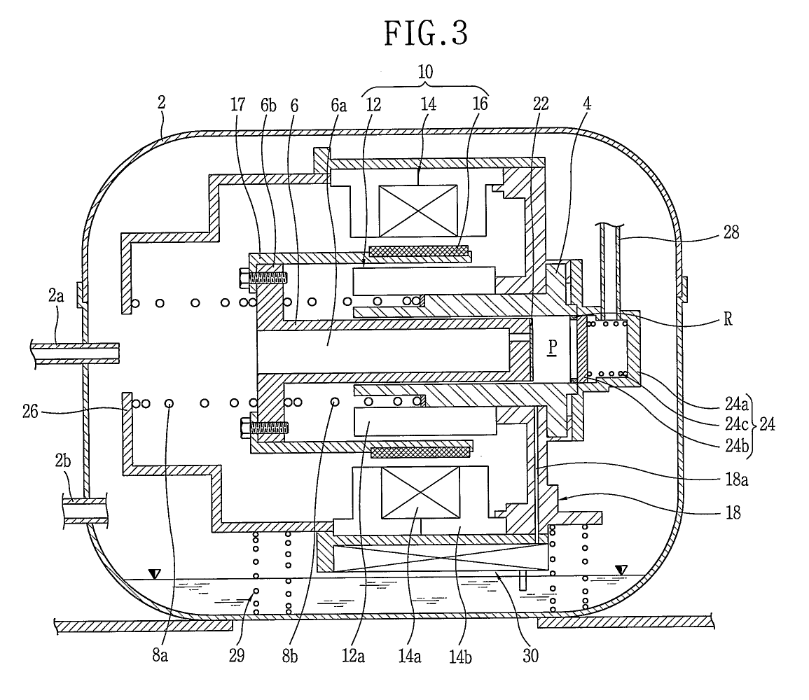

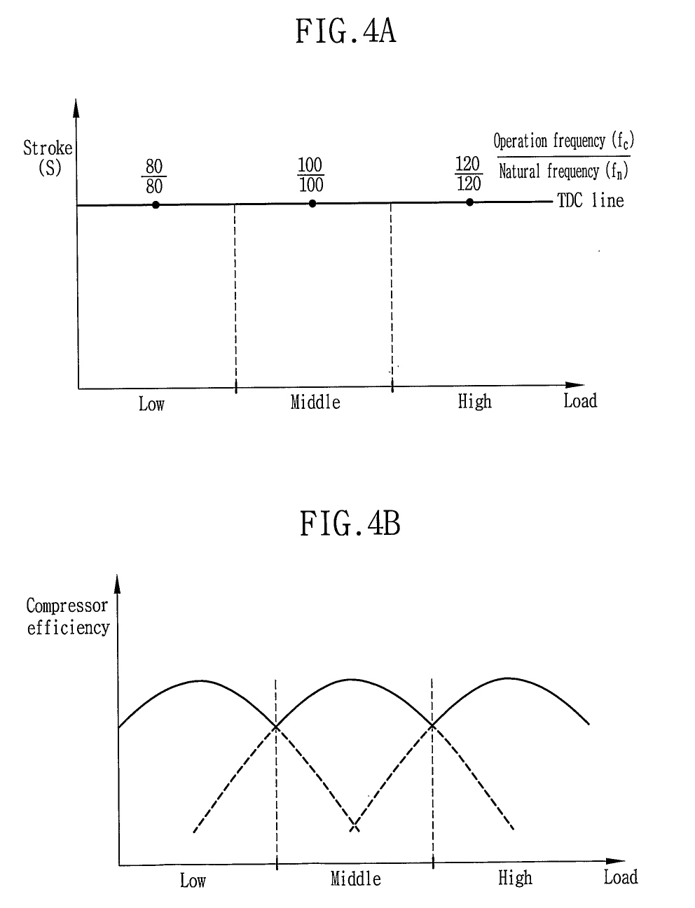

As shown in FIG. 3, in the linear compressor, an inlet tube 2a and an outlet tube 2b through which refrigerants are sucked and discharged are installed at one side of a closed vessel 2, a cylinder 4 is fixedly installed inside the closed vessel 2, a piston 6 is installed inside the cylinder 4 to be linearly reciprocated to compress the refrigerants sucked into a compression space P in the cylinder 4, and various springs are installed to be elastically supported in the motion direction of the piston 6. Here, the piston 6 is connected to a linear motor 10 for generating a linear reciprocation driving force. As depicted in FIGS. 4A and 4B, even if a natural frequency fₙ of the piston 6 is varied by load, the linear motor 10 controls its operation frequency f_{c} to be synchronized with the natural frequency fₙ of the piston 6, and also controls a stroke S of the piston 6 to vary a compression capacity.

In addition, a suction valve 22 is installed at one end of the piston 6 contacting the compression space P, and a discharge valve assembly 24 is installed at one end of the cylinder 4 contacting the compression space P. The suction valve 22 and the discharge valve assembly 24 are automatically controlled to be opened or closed according to the inside pressure of the compression space P, respectively.

The top and bottom shells of the closed vessel 2 are coupled to hermetically seal the closed vessel 2. The inlet tube 2a through which the refrigerants are sucked and the outlet tube 2b through which the refrigerants are discharged are installed at one side of the closed vessel 2. The piston 6 is installed inside the cylinder 4 to be elastically supported in the motion direction to perform the linear reciprocation. The linear motor 10 is connected to a frame 18 outside the cylinder 4 to compose an assembly. The assembly is installed on the inside bottom surface of the closed vessel 2 to be elastically supported by a support spring 29.

The inside bottom surface of the closed vessel 2 contains oil, an oil supply device 30 for pumping the oil is installed at the lower end of the assembly, and an oil supply tube 18a for supplying the oil between the piston 6 and the cylinder 4 is formed inside the frame 18 at the lower side of the assembly. Accordingly, the oil supply device 30 is operated by vibrations generated by the linear reciprocation of the piston 6, for pumping the oil, and the oil is supplied to the gap between the piston 6 and the cylinder 4 along the oil supply tube 18a, for cooling and lubrication.

The cylinder 4 is formed in a hollow shape so that the piston 6 can perform the linear reciprocation, and has the compression space P at its one side. Preferably, the cylinder 4 is installed on the same straight line with the inlet tube 2a in a state where one end of the cylinder 4 is adjacent to the inside portion of the inlet tube 2a.

The piston 6 is installed inside one end of the cylinder 4 adjacent to the inlet tube 2a to perform linear reciprocation, and the discharge valve assembly 24 is installed at one end of the cylinder 4 in the opposite direction to the inlet tube 2a.

Here, the discharge valve assembly 24 includes a discharge cover 24a for forming a predetermined discharge space at one end of the cylinder 4, a discharge valve 24b for opening or closing one end of the cylinder 4 near the compression space P, and a valve spring 24c which is a kind of coil spring for applying an elastic force between the discharge cover 24a and the discharge valve 24b in the axial direction. An O-ring R is inserted onto the inside circumferential surface of one end of the cylinder 4, so that the discharge valve 24a can be closely adhered to one end of the cylinder 4.

An indented loop pipe 28 is installed between one side of the discharge cover 24a and the outlet tube 2b, for guiding the compressed refrigerants to be externally discharged, and preventing vibrations generated by interactions of the cylinder 4, the piston 6 and the linear motor 10 from being applied to the whole closed vessel 2.

Therefore, when the piston 6 is linearly reciprocated inside the cylinder 4, if the pressure of the compression space P is over a predetermined discharge pressure, the valve spring 24c is compressed to open the discharge valve 24b, and the refrigerants are discharged from the compression space P, and then externally discharged along the loop pipe 28 and the outlet tube 2b.

A refrigerant passage 6a through which the refrigerants supplied from the inlet tube 2a flows is formed at the center of the piston 6. The linear motor 10 is directly connected to one end of the piston 6 adjacent to the inlet tube 2a by a connection member 17, and the suction valve 22 is installed at one end of the piston 6 in the opposite direction to the inlet tube 2a. The piston 6 is elastically supported in the motion direction by various springs.

The suction valve 22 is formed in a thin plate shape. The center of the suction valve 22 is partially cut to open or close the refrigerant passage 6a of the piston 6, and one side of the suction valve 22 is fixed to one end of the piston 6a by screws.

Accordingly, when the piston 6 is linearly reciprocated inside the cylinder 4, if the pressure of the compression space P is below a predetermined suction pressure lower than the discharge pressure, the suction valve 22 is opened so that the refrigerants can be sucked into the compression space P, and if the pressure of the compression space P is over the predetermined suction pressure, the refrigerants of the compression space P are compressed in the close state of the suction valve 22.

Especially, the piston 6 is installed to be elastically supported in the motion direction. In detail, a piston flange 6b protruded in the radial direction from one end of the piston 6 adjacent to the inlet tube 2a is elastically supported in the motion direction of the piston 6 by mechanical springs 8a and 8b such as coil springs. The refrigerants included in the compression space P in the opposite direction to the inlet tube 2a are operated as gas springs due to an elastic force, thereby elastically supporting the piston 6.

Here, the mechanical springs 8a and 8b have constant mechanical spring constants Kₘ regardless of the load, and are preferably installed side by side with a support frame 26 fixed to the linear motor 10 and the cylinder 4 in the axial direction from the piston flange 6b. Also, preferably, the mechanical spring 8a supported by the support frame 26 and the mechanical spring 8a installed on the cylinder 4 have the same mechanical spring constant Kₘ.

However, the gas spring has a gas spring constant K_{g} varied by the load. When an ambient temperature rises, the pressure of the refrigerants increases, and thus the elastic force of the gases in the compression space P increases. As a result, the more the load increases, the higher the gas spring constant K_{g} of the gas spring is.

While the mechanical spring constant Kₘ is constant, the gas spring constant K_{g} is varied by the load. Therefore, the total spring constant is also varied by the load, and the natural frequency fₙ of the piston 6 is varied by the gas spring constant K_{g} in the above Formula 1.

Even if the load is varied, the mechanical spring constant Kₘ and the mass M of the piston 6 are constant, but the gas spring constant K_{g} is varied. Thus, the natural frequency fₙ of the piston 6 is remarkably influenced by the gas spring constant K_{g} varied by the load. In the case that the algorithm of varying the natural frequency fₙ of the piston 6 by the load is obtained and the operation frequency f_{c} of the linear motor 10 is synchronized with the natural frequency fₙ of the piston 6, efficiency of the linear compressor can be improved and the load can be rapidly overcome.

The load can be measured in various ways. Since the linear compressor is installed in a refrigeration/air conditioning cycle for compressing, condensing, evaporating and expanding refrigerants, the load can be defined as a difference between a condensing pressure which is a pressure of condensing refrigerants and an evaporating pressure which is a pressure of evaporating refrigerants. In order to improve accuracy, the load is determined in consideration of an average pressure of the condensing pressure and the evaporating pressure.

That is, the load is calculated in proportion to the difference between the condensing pressure and the evaporating pressure and the average pressure. The more the load increases, the higher the gas spring constant K_{g} is. For example, if the difference between the condensing pressure and the evaporating pressure increases, the load increases. Even though the difference between the condensing pressure and the evaporating pressure is not changed, if the average pressure increases, the load increases. The gas spring constant K_{g} increases according to the load.

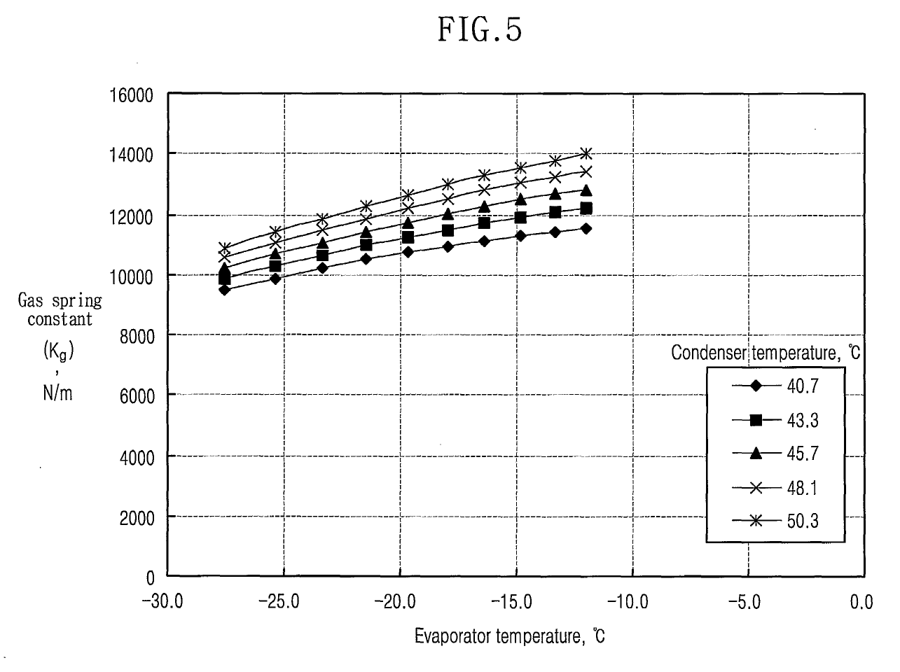

As illustrated in FIG. 5, a condensing temperature proportional to the condensing pressure and an evaporating temperature proportional to the evaporating pressure are measured, and the load is calculated in proportion to a difference between the condensing temperature and the evaporating temperature and an average temperature.

In detail, the mechanical spring constant Kₘ and the gas spring constant K_{g} can be determined by various experiments. In accordance with the present invention, the mechanical springs 8a and 8b of the linear compressor have a smaller mechanical spring constant Kₘ than the mechanical springs of the conventional linear compressor, which increases the ratio of the gas spring constant K_{g} to the total spring constant K_{T}. Therefore, the natural frequency fₙ of the piston 6 is varied by the load within a relatively large range, and the operation frequency fₙ of the linear motor 10 is easily synchronized with the natural frequency fₙ of the piston 6 varied by the load.

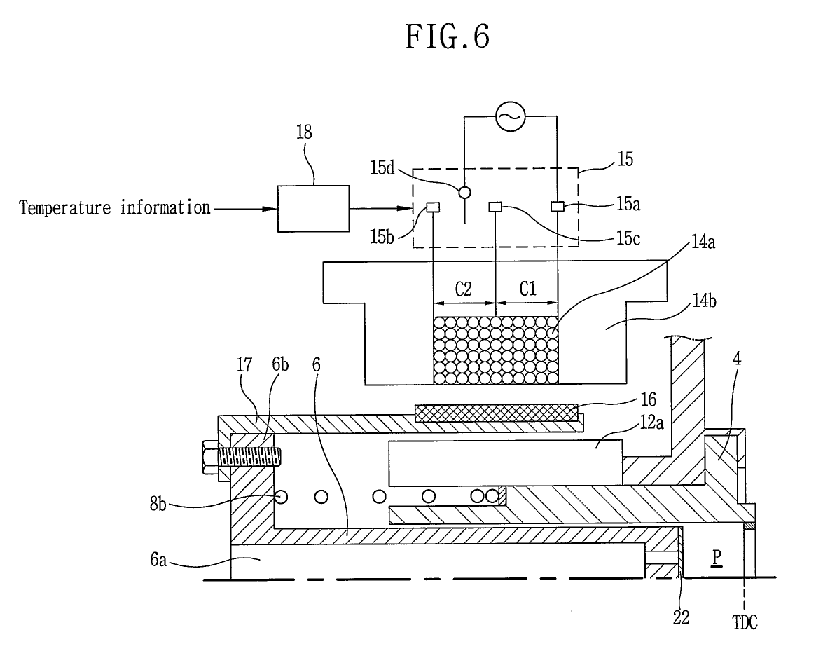

Referring to FIG. 6, the linear motor 10 includes an inner stator 12 formed by stacking a plurality of laminations 12a in the circumferential direction, and fixedly installed outside the cylinder 4 by the frame 18, an outer stator 14 formed by stacking a plurality of laminations 14b at the periphery of a coil wound body 14a in the circumferential direction, and installed outside the cylinder 4 by the frame 18 with a predetermined gap from the inner stator 12, and a permanent magnet 16 positioned at the gap between the inner stator 12 and the outer stator 14, and connected to the piston 6 by the connection member 17. Here, the coil wound body 14a can be fixedly installed outside the inner stator 12.

Especially, the linear motor 10 can variously change the stroke S of the piston 6. Preferably, the coil wound body 14a is divided into two or more coil wound sections C1 and C2 in the motion direction of the piston 6, and the linear motor 10 applies the current to one or more coil wound sections C1 and C2 to generate an electromagnetic force.

The linear motor 10 further includes a branch means 15 for selecting one or more coil wound sections C1 and C2, and applying an externally-inputted current to the selected coil wound sections C1 and C2, and a control means 18 for controlling the branch means 15 according to the load.

Here, the coil wound body 14a is divided so that the length of the coil wound sections C1 and C2 can be proportional to the stroke S of the piston 6 varied by the load. Each of the coil wound sections C1 and C2 has different inductance L. For example, a coil wound number and/or a coil diameter can be varied in the coil wound sections C1 and C2.

The branch means 15 includes connection terminals 15a, 15b and 15c connected to end points of the coil wound body 14a and a connection point between the coil wound sections C1 and C2, and a switch 15d for selecting two of the connection terminals 15a, 15b and 15c to apply the current to the selected connection terminals.

The control means 18 receives the condensing temperature and the evaporating temperature of the refrigerants, decides the load, and controls the operation of the branch means 15 according to the load. As the load increases, the control means 18 controls the current to be applied to more coil wound sections C1 and C2.

Preferably, even if the stroke S of the piston 6 is varied, the linear motor 10 allows the piston 6 to perform compression to reach the TDC. In detail, in the branch means 15, the connection terminal 15a branched from the point adjacent to the TDC between the both end points of the coil wound body 14a is always connected to the input current, and one of the other connection terminals 15b and 15c is selectively connected by the switch 15d.

For example, in the linear motor 10, the coil wound body 14a is divided into first and second coil wound sections C1 and C2 from the TDC, the same diameter of coils are wound in the first and second coil wound sections C1 and C2, and the axial direction length of the first coil wound section C1 is 30 to 80% of the axial direction length of the coil wound body 14a.

Accordingly, when the high refrigeration is necessary due to relatively large load, the linear motor 10 applies the current to the first and second coil wound sections C1 and C2, so that the electromagnetic force can be operated in the whole axial direction length of the coil wound body 14a. In the case that the low refrigeration is required due to relatively small load, the linear motor 10 applies the current merely to the first coil wound section C1, so that the electromagnetic force can be operated in part of the axial direction length of the coil wound body 14a.

The operation of the linear motor 10 by the load will now be explained.

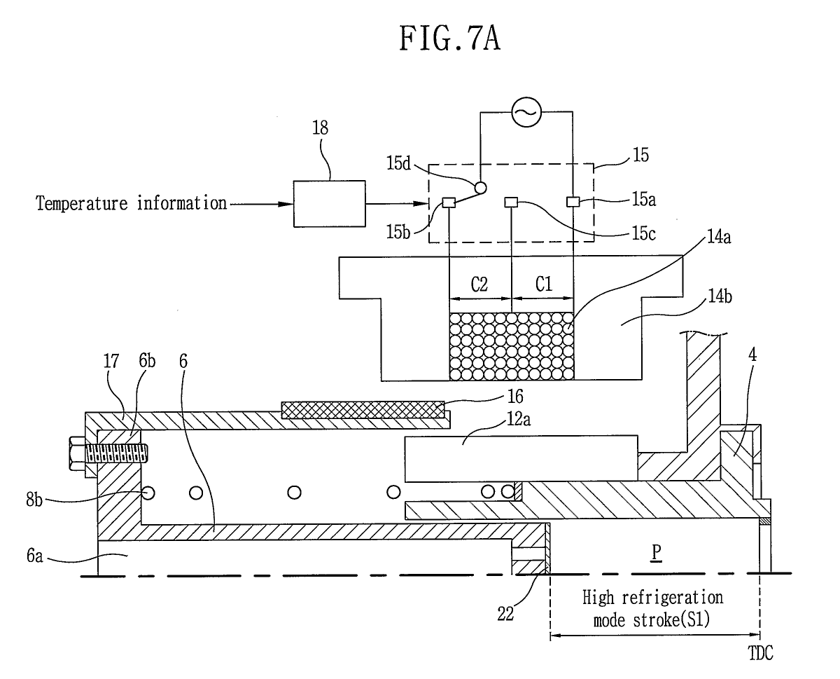

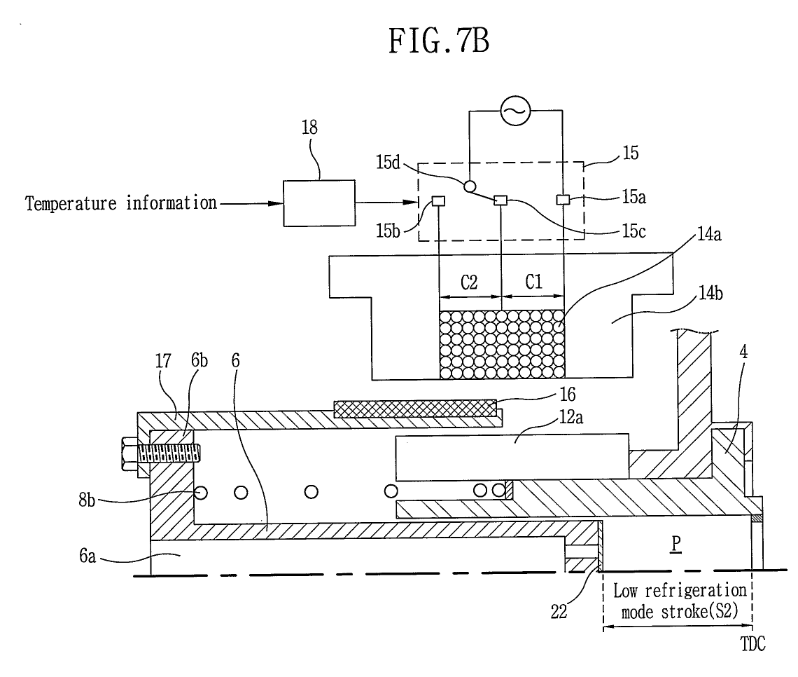

As illustrated in FIG. 7A, when the high refrigeration is necessary, the linear motor 10 is operated in the high refrigeration mode. Since the stroke S of the piston 6 increases due to large load, the compression capacity increases to rapidly handle the load.

Here, the control means 18 receives the condensing temperature and the evaporating temperature, decides the load, and controls the branch means 15 according to the decision result. The switch 15d is connected to the connection terminal 15b branched from one end of the coil wound body 14a, for applying the current to the first and second coil wound sections C1 and C2. The electromagnetic force generated at the periphery of the coils in the first and second coil wound sections C1 and C2 and the magnetic force of the permanent magnet 16 interact with each other. As a result, the permanent magnet 16 is linearly reciprocated to reach the TDC with high refrigeration mode stroke S1, for compressing the refrigerants, thereby increasing the compression capacity.

As the load increases, the gas spring constant K_{g} increases and the natural frequency fₙ of the piston 6 increases at the same time. The operation frequency f_{c} of the linear motor 10 is synchronized with the natural frequency fₙ of the piston 6 by the frequency estimation algorithm. Therefore, the linear compressor is operated in a resonance state, to improve compression efficiency.

On the other hand, as depicted in FIG. 7B, when the low refrigeration is required, the linear motor 10 is operated in the low refrigeration mode. Since the stroke S of the piston 6 decreases due to small load, the compression capacity decreases to efficiently handle the load.

Here, the control means 18 receives the condensing temperature and the evaporating temperature, decides the load, and controls the branch means 15 according to the decision result. The switch 15d is connected to the connection terminal 15c branched from the first and second coil wound sections C1 and C2, for applying the current to the first coil wound section C1. The electromagnetic force generated at the periphery of the coil in the first coil wound section C1 and the magnetic force of the permanent magnet 16 interact with each other. Accordingly, the permanent magnet 16 is linearly reciprocated to reach the TDC with low refrigeration mode stroke S2, for compressing the refrigerants, thereby decreasing the compression capacity.

As the load decreases, the gas spring constant K_{g} decreases and the natural frequency fₙ of the piston 6 decreases at the same time. The natural frequency fₙ of the piston 6 is estimated by the frequency estimation algorithm using the data of the gas spring as shown in FIG. 5, and the operation frequency f_{c} of the linear motor 10 is synchronized with the estimated natural frequency fₙ. As a result, the linear compressor is operated in the resonance state, to improve compression efficiency.

As described above, variations of the gas spring constant K_{g} and the natural frequency fₙ by the load are estimated by the frequency estimation algorithm, and the operation frequency f_{c} of the linear motor 10 is synchronized with the natural frequency fₙ, so that the linear motor can be operated in the resonance state to maximize compression efficiency.

Since the coil wound body 14a of the linear motor 10 is divided into two or more coil wound sections in the motion direction of the piston 6 and the current is applied to one or more coil wound sections, the stroke S of the piston 6 is adjusted by controlling the regions in which the electromagnetic force is generated at the periphery of the coil wound body 14a. Accordingly, the linear compressor can actively handle and rapidly overcome the load, and reduce power consumption.

The linear compressor in which the moving magnet type linear motor is operated and the piston connected to the linear motor is linearly reciprocated inside the cylinder to suck, compress and discharge the refrigerants has been explained in detail on the basis of the preferred embodiments and accompanying drawings. However, although the preferred embodiments of the present invention have been described, it is understood that the present invention should not be limited to these preferred embodiments but various changes and modifications can be made by one skilled in the art within the spirit and scope of the present invention as hereinafter claimed.

1. A linear compressor, comprising: a fixed member having a compression space inside; a movable member linearly reciprocated in the fixed member in the axial direction, for compressing refrigerants sucked into the compression space; one or more springs installed to elastically support the movable member in the motion direction of the movable member, spring constants of which being varied by load; and a linear motor installed to be connected to the movable member, for linearly reciprocating the movable member in the axial direction, an operation frequency and a stroke being varied by the load.

2. The linear compressor of claim 1, which is installed in a refrigeration/air conditioning cycle, wherein the load is calculated in proportion to a difference between a pressure of condensing refrigerants (condensing pressure) and a pressure of evaporating refrigerants (evaporating pressure) in the refrigeration/air conditioning cycle.

3. The linear compressor of claim 2, wherein the load is additionally calculated in proportion to a pressure that is an average of the condensing pressure and the evaporating pressure (average pressure).

4. The linear compressor of any one of claims 1 to 3, wherein the linear motor synchronizes its operation frequency with a natural frequency of the movable member varied in proportion to the load.

5. The linear compressor of claim 4, wherein, even though the stroke is varied by the load, the linear motor linearly reciprocates the movable member to reach a top dead center.

6. The linear compressor of claim 1, wherein the linear motor comprises: an inner stator formed by stacking a plurality of laminations in the circumferential direction to cover the periphery of the fixed member; an outer stator disposed outside the inner stator at a predetermined interval, and formed by stacking a plurality of laminations in the circumferential direction; a coil wound body installed at any one of the inner stator and the outer stator, for generating an electromagnetic force between the inner stator and the outer stator according to current flow; and a permanent magnet positioned at the gap between the inner stator and the outer stator, connected to the movable member, and linearly reciprocated by interactions with the electromagnetic force of the coil wound body.

7. The linear compressor of claim 6, wherein the coil wound body is divided into two or more coil wound sections in the axial direction, and the linear motor comprises a branch means for selecting one or more coil wound sections and applying an input current to the selected coil wound sections, and a control means for controlling the branch means according to the load.

8. The linear compressor of claim 7, wherein the branch means selects two of both end points of the coil wound body and connection points between the coil wound sections, and applies the input current to the selected points.

9. The linear compressor of claim 8, wherein the branch means always selects the point adjacent to the top dead center between the both end points of the coil wound body.

10. The linear compressor of either claim 7 or 9, wherein the stroke is proportional to the axial direction length of the coil wound sections to which the current is applied.

11. The linear compressor of claim 7, wherein the coil wound sections of the coil wound body have different inductance.

12. The linear compressor of claim 11, wherein a coil wound number is different in each of the coil wound sections of the coil wound body.

13. The linear compressor of claim 11, wherein a different diameter of coils are wound in each of the coil wound sections of the coil wound body.

14. The linear compressor of claim 7, wherein the coil wound body is divided into first and second coil wound sections from the top dead center.

15. The linear compressor of claim 14, wherein the axial direction length of the first coil wound section is 30 to 80% of the axial direction length of the coil wound body.
